(19) United States
(12) Patent Application Publication
(10) Pub. No.: US 2014/0072508 A1
(43) Pub. Date: Mar. 13, 2014

(54) Method for Transforming Nitrogen-Containing Compounds

(71) Applicants: Silke Sauerbeck, Bruckmuhl OT Heufeld (DE); Frank Klose, Rosenheim (DE); Arno Tissler, Tegemheim (DE); Grigory Reznikov, Bruckmuhl (DE)

(72) Inventors: Silke Sauerbeck, Bruckmuhl OT Heufeld (DE); Frank Klose, Rosenheim (DE); Arno Tissler, Tegemheim (DE); Grigory Reznikov, Bruckmuhl (DE)

(73) Assignee: Clariant Produkte (Deutschland) GmbH, Frankfurt / Main (DE)

(21) Appl. No.: 13/997,109

(22) PCT Filed: Dec. 21, 2011
(86) PCT No.: PCT/EP2011/073693

§ 371 Date: Aug. 13, 2013

(30) Foreign Application Priority Data
Dec. 22, 2010 (DE) 10 2010 055 728.5

(51) Int. Cl. B01D 53/56; B01J 29/89

(52) U.S. Cl. CPC B01D 53/565; B01J 29/89
USPC 423/700; 423/239.2

(57) ABSTRACT

The invention relates to a method for the selective catalytic transformation of nitrogen-containing compounds. The transformation relates to the selective catalytic reduction (SCR) of nitrogen oxides, or the selective catalytic oxidation (SCO) of nitrogen hydrides and nitrogen-containing organic compounds, preferably in waste gas flows of combustion processes with motors and without motors and industrial applications. The catalytic converter comprises a titano-(silico)-alumo-phosphate.

The present invention relates to a method for the selective catalytic conversion of nitrogen-containing compounds. The conversion relates to either the selective catalytic reduction (SCR) of nitrogen oxides or the selective catalytic oxidation (SCO) of nitrogen-hydrogen compounds and nitrogen-containing organic compounds, preferably in exhaust gas streams from combustion processes with engines and without engines as well as industrial applications. The catalyst comprises a titano-alumino-phosphate or titano-silico-alumino-phosphate (hereafter called titano-(silico)-alumino-phosphate).

By selective catalytic reduction of nitrogen oxides is meant, within the meaning of this invention, their conversion with reducing agents such as hydrocarbons, CO, ammonia, other nitrogen-hydrogen compounds and nitrogen-containing organic compounds to nitrogen, water (and carbon dioxide).

By selective catalytic oxidation is meant, within the meaning of this invention, the conversion of ammonia, other nitrogen-hydrogen compounds and nitrogen-containing organic compounds to nitrogen, water (and carbon dioxide). In other words the present invention relates to the use of a titano-(silico)-alumino-phosphate for the selective catalytic reduction of nitrogen oxides and for the selective catalytic oxidation of nitrogen-hydrogen compounds and nitrogen-containing organic compounds, preferably in exhaust gas streams from combustion processes with engines and without engines as well as industrial applications. Combustion processes with engines, such as diesel engines and gasoline injection engines as well as combustion processes without engines, but also specific industrial applications, e.g. the production of nitric acid, require so-called DeNOx-catalysts, which reduce nitrogen oxides in the exhaust gas stream to nitrogen by selective catalytic reduction. Molecular sieves which offer a large surface area and can be introduced, surface-active, into the catalytically active components are often required for this. In the state of the art, as a rule zeolites or zeolite-like materials that are doped with an active metal representing the essential catalytically active component are used as molecular sieves for this purpose.

In the state of the art alumino-silicates (zeolites), alumino-phosphates (ALPOs) and silico-alumino-phosphates (SAPOs) for example have for a long time been known as active components for refinery, petrochemical and chemical catalysts as well as for exhaust gas purification in both stationary and mobile applications. These groups are often also referred to only by the collective term zeolites.

Generally, by silico-alumino-phosphates (SAPOs) are meant molecular sieves that are obtained starting from alumino-phosphates (general formula (AlPO₄-n)) by isomorphic exchange of phosphorus with silicon and correspond to the general formula (SiₓAl_{y}P_{z})O₂ (anhydrous) (EP 0 585 683), wherein x+y+z=1 and the SAPO framework has negative charges, the number of which depends on how many phosphorus atoms have been replaced by silicon atoms, or the number of which depends on how great the excess of aluminium atoms is with respect to the phosphorus atoms.

Structures of this group are graded by the “Structure Commission of the International Zeolite Association” on the basis of their pore size according to IUPAC rules (International Union of Pure and Applied Chemistry). They crystallize into more than 200 different compounds in two dozen different structures. They are classified on the basis of their pore sizes.

SAPOs can typically be obtained by means of hydrothermal synthesis, starting from reactive alumino-phosphate gels, or the individual Al, Si, P components. The crystallization of the obtained silico-alumino-phosphates (SAPOs) is achieved by means of the addition of structure-directing templates, crystal nuclei or elements (EP 103 117 A1, U.S. Pat. No. 4,440,871, U.S. Pat. No. 7,316,727).

The framework structure of the SAPOs is constructed from regular, three-dimensional spatial networks with characteristic pores and channels that can be connected to each other in one, two or three dimensions. The above-mentioned structures are formed from corner-connected tetrahedral units (AlO₄, SiO₄, PO₄), consisting of aluminium, silicon and phosphorus, tetracoordinated by oxygen in each case. The tetrahedra are called primary structural units the connecting of which results in the formation of secondary structural units. Silico-alumino-phosphates (SAPOs) crystallize inter alia in the known CHA structure (chabazite), classified according to IUPAC on the basis of their specific CHA unit.

In the alumino-phosphates there is charge neutrality because of the equal number of aluminium and phosphorus atoms. These systems thus have the disadvantage that they require no counterions in voids to equalize the charge. Thus it is also not possible to effectively incorporate catalytically active metal ions into these voids by ion binding. These alumino-phosphates are therefore not very suitable as molecular sieves in catalysts for the removal of nitrogen oxides from the exhaust gas stream of combustion engines.

As a result of the isomorphic exchange/replacement of phosphorus with silicon, surplus negative charges which are compensated for by the incorporation of additional cations into the pore and channel system form in silico-alumino-phosphates. The level of phosphorus-silicon substitution starting from alumino-phosphates thus determines the number of cations required for balancing, and thus the maximum possible charging of the compounds with positively charged cations, e.g. hydrogen or metal ions. The acid catalytic properties of the silico-alumino-phosphates are determined by the incorporation of the cations and can be used as catalyst components by means of targeted ion exchange with respect to their activity and selectivity. The so-called SAPO-34 with CHA structure and pore openings of approximately 3.5 Å is particularly preferably used as molecular sieve in catalysts. Silico-alumino-phosphates (SAPOs) are suitable as molecular sieves in particular in so-called SCR-catalysts for the selective catalytic reduction of NOₓ as, in the selective reduction of NOₓ gases, high hydrothermal stability is often required, as exhaust gas streams with high water content frequently impact on the catalyst at high temperatures. Also in the case of SCO applications exhaust gases with a high water content often have to be purified, with the result that here too the silico-alumino-phosphates have technical advantages and are thus of significant economic interest. In the case of the named SAPOs, there is no reduction in the surface area (compared with zeolites) and virtually no reduction in the acidity under reaction conditions. However, SAPOs nevertheless have the disadvantage that they are relatively thermally unstable in the aqueous phase. Thus e.g. SAPO-34 already amorphizes at low temperatures—inter alia already during the production of the catalyst in aqueous phases.

The object of the present invention was therefore to provide a catalyst material for SCR or SCO, which suffers no damage already during the catalyst preparation and then has as constant an activity as possible over a long lifetime.

This object was achieved by the method according to the invention for the selective catalytic conversion of nitrogen-containing compounds, wherein a catalyst that comprises titano-(silico)-alumino-phosphate is used, as well as by the use of titano-(silico)-alumino-phosphate in SCR and SCO applications. The substitution of copper atoms for silicon atoms already leads to higher activity at lower temperatures in the case of the titano-(silico)-alumino-phosphates used, compared with the silico-alumino-phosphates.

Like the named SAPOs, the titano-(silico)-alumino-phosphates within the context of the present invention are crystalline substances with a spatial network structure which consists of TiO₄/(SiO₄)/AlO₄/PO₄ tetrahedra and is linked by common oxygen atoms to form a regular three-dimensional network. All these named tetrahedron units together form the so-called “framework”. Further units, which do not consist of the tetrahedron units of the base framework, are referred to as so-called “extra framework”.

The structures of the titano-(silico)-alumino-phosphates contain voids which are characteristic of each structural type. Like the zeolites, this structural class also represents molecular sieves. They are divided into different structures according to their topology. The crystal framework contains open voids in the form of channels and cages which are normally occupied by water molecules and additional framework cations which can be replaced. In the case of the so-called alumino-phosphates, at least in the “framework” of the titano-(silico)-alumino-phosphate, there is one phosphorus atom for each aluminium atom, with the result that the charges cancel each other out. If titanium atoms are substituted for the phosphorus atoms, the titanium atoms form an excess negative charge which is compensated for by cations. The inside of the pore system represents the catalytically active surface. The less phosphorus a titano-(silico)-alumino-phosphate contains relative to aluminium in the framework, the denser the negative charge is in its lattice and the more polar its inner surface is. The pore size and structure are determined, in addition to the parameters during production, i.e. use or type of templates, pH, pressure, temperature, presence of seed crystals, by the P/Al/Ti/(Si) ratio which accounts for the greatest part of the catalytic character of a titano-alumino-phosphate or titano-silico-alumino-phosphate. The substitution of titanium atoms for phosphorus atoms with respect to the framework gives rise to a deficit of positive charges, with the result that the molecular sieve is negatively charged overall. The negative charges are compensated for by incorporating cations into the pores of the zeolite material. In addition to titanium atoms, silicon atoms can also replace the phosphorus atoms as can be seen from the above-mentioned optional presence of silicon placed in brackets. These then also give rise to negative charges, which have to be compensated for by cations.

The titano-(silico)-alumino-phosphates used according to the invention are differentiated—as also in the state of the art—mainly according to the geometry of the voids which are formed by the rigid network of the TiO₄/AlO₄/(SiO₄)/PO₄ tetrahedra. The entrances to the voids are formed from 8, 10 or 12 ring atoms with respect to the metal atoms which form the entrance opening, wherein a person skilled in the art uses the terms narrow-, average- and wide-pored structures here. According to the invention narrow-pored structures are preferred here. These titano-(silico)-alumino-phosphates can have a uniform structure, e.g. a VFI or AET topology with linear channels, wherein other topologies are however also conceivable, in which larger voids attach themselves behind the pore openings. According to the invention titano-(silico)-alumino-phosphates with openings made of eight tetrahedron atoms, i.e. narrow-pored materials, are preferred. These preferably have an opening diameter of approximately 3.1 to 5 Å, particularly preferably 3.4 to 3.6 Å.

By the term “molecular sieve” is meant natural and synthetically produced framework structures with voids and channels, such as for example zeolites and related materials which have a high absorption capability for gases, vapours and dissolved substances with specific molecular sizes.

It was surprisingly found that titanium-containing (silico)-alumino-phosphates are particularly suitable as molecular sieves in exhaust gas purification catalyst components, in particular SCR and SCO catalysts. The titano-(silico)-alumino-phosphates are eminently suitable as molecular sieves in SCR and SCO catalysts due to their high phase purity, their temperature stability, their high possible level of charge with transition metal ions and their high ammonia storage capacity.

By the term “nitrogen oxide” is meant in principle all conceivable nitrogen oxides of the general formula NₓO_{y}, which can form for example in combustion processes with engines and without engines, but also in industrial processes.

By the term “catalyst” in the method according to the invention is meant preferably a support body which comprises a molecular sieve based on titano-(silico)-alumino-phosphate and preferably a catalytically active metal in the form of a cation. The support body can be formed as a full extrudate from the molecular sieve, or be present in the form of a support body that is coated with a composition containing the molecular sieve.

The support body is preferably embedded in a unit incorporated in the exhaust pipe. The unit preferably has a catalyst bed in which the support bodies are located. By passing the exhaust gas stream over or through the support bodies located in the catalyst bed, in the case of SCR applications the nitrogen oxides and in the case of SCO applications nitrogen-hydrogen compounds such as ammonia and nitrogen-containing organic compounds are preferably converted to nitrogen, water (and carbon dioxide). In the SCR applications according to the invention, the nitrogen oxides are preferably reduced to N₂ using a reducing agent. In the SCO applications according to the invention nitrogen-hydrogen compounds such as ammonia and nitrogen-containing organic compounds are preferably oxidized to N₂ and water (and CO₂) using an oxidant.

In the case of SCR applications, within the meaning of this invention, any reducing agent that is suitable for the catalytic reduction of nitrogen oxides can be used as reducing agent. According to the invention the following reducing agents are preferred: NH₃, urea, hydrocarbons, carbon monoxide, fuel not converted in the engine compartment in the case of combustion processes with engines, wherein NH₃ or urea are particularly preferred.

In the case of SCO applications, within the meaning of this invention, any oxidant that is suitable for the catalytic oxidation of nitrogen-hydrogen compounds, such as ammonia and nitrogen-containing organic compounds, can be used as oxidant. According to the invention the following oxidants are preferred: oxygen, air, laughing gas.

The titano-(silico)-alumino-phosphate used in the method according to the invention preferably has an acidity of 1000-1500 μmol/g and particularly preferably an acidity of 1100-1400 μmol/g, which is determined by means of temperature-programmed desorption of ammonia. An acidity in this range is particularly important for storing the predominantly acidic reducing agents in the case of SCR applications, or the nitrogen-hydrogen compounds such as ammonia and nitrogen-containing organic compounds in the case of SCO applications.

Further preferably, the titano-(silico)-alumino-phosphate in the method according to the invention has a BET surface area within the range of from 200 to 1200 m²/g, particularly preferably 400 to 850 m²/g, even more preferably 500 to 750 m²/g. The BET surface area of the molecular sieve should not be too small, as there is then insufficient contact of the nitrogen oxides with the catalytically active components and there is thus inadequate reduction of the nitrogen oxides. Too large a BET surface area brings with it the disadvantage that, due to the low density of the material, the latter is no longer sufficiently temperature-stable. The BET surface area is determined by means of adsorption of nitrogen according to DIN 66132.

The titano-(silico)-alumino-phosphate preferably has a so-called CHA structure, as is known from the classification of the different topologies of zeolites. Particularly preferably, the titano-(silico)-alumino-phosphate is a TAPO-34 (titano-alumino-phosphate-34) or TAPSO-34 (titano-silico-alumino-phosphate-34). The excellent hydrothermal stability of TAPO-34 or TAPSO-34 and also the small pore openings make TAPO-34 or TAPSO-34 ideally suitable as selective catalyst for the reduction of nitrogen oxides. TAPSO-34 is quite particularly preferably used as titano-(silico)-alumino-phosphate.

In the state of the art zeolites with MFI- and BEA-structures are mainly used, not zeolites with CHA structure. However their thermal stability is very limited. It was thus ascertained, for example, that in a hydrothermal ageing test (conditions: 10 volume percent H₂O; 700° C.; duration 24 hours) the surface area in the case of a zeolite with BEA structure is reduced by 11% and in the case of a zeolite with MFI structure by 8%. In addition, after the ageing test both materials exhibit significantly lower values with respect to the acidity, which was determined with temperature-programmed desorption of ammonia. The zeolite with the BEA structure loses 54% of its acidity and the zeolite with the MFI structure loses 77% of its acidity. In contrast the titanium-containing (silico)-alumino-phosphate according to the invention (for example TAPSO-34) loses only 19% of its acidity in the ageing test. Due to its high hydrothermal stability the titano-(silico)-alumino-phosphate used according to the invention is thus particularly suitable for use in a humid atmosphere at high temperatures, such as those prevailing in specific SCR and SCO applications with engines and without engines.

A titanium-containing (silico)-alumino-phosphate with a CHA structure, which preferably has a structure with small pore openings of approximately 3.5 Å, has proved particularly suitable within the meaning of this invention. These structures are particularly suitable for applications with engines, as they have a high adsorption of unburnt fuel in the starting phase of engines as so-called cold start traps, which fuel can be used as reducing agent for the nitrogen oxides after heating up of the system.

The titano-silico-alumino-phosphates used in the method according to the invention are preferably selected from TAPSO-5, TAPSO-8, TAPSO-11, TAPSO-16, TAPSO-17, TAPSO-18, TAPSO-20, TAPSO-31, TAPSO-34, TAPSO-35, TAPSO-36, TAPSO-37, TAPSO-40, TAPSO-41, TAPSO-42, TAPSO-44, TAPSO-47, TAPSO-56. TAPSO-5, TAPSO-11 or TAPSO-34 are particularly preferred as these have a particularly high hydrothermal stability vis-à-vis water. TAPSO-5, TAPSO-11 and TAPSO-34 are also particularly suitable due to their good properties as catalyst in different processes because of their microporous structure and because they are highly suitable as adsorbents due to their high adsorption capacity. Moreover, they also have a low regeneration temperature, as they already reversibly release adsorbed water or adsorbed other small molecules at temperatures between 30° C. and 90° C. According to the invention the use of microporous titano-silico-alumino-phosphates with CHA structure is particularly suitable. The molecular sieve used in the method according to the invention is quite particularly preferably a so-called TAPSO-34, as is known in the state of the art for example from EP 161 488 and U.S. Pat. No. 4,684,617.

Because phosphorus atoms are replaced by titanium or silicon atoms, the titano-(silico)-alumino-phosphate used in the method according to the invention has negative charges, which are compensated for by cations. In the synthesis of titano-(silico)-alumino-phosphates, which has been known for many years from EP 161 488, the molecular sieve preferably exists in the protonated or in the Na⁺ Form. In the method according to the invention the titano-(silico)-alumino-phosphate is present in a modified form, in which at least one species of transition metal cations is preferably present in the voids as counter-ions in order to compensate for the negative charges. The transition metal cations present inside the framework structure give the structure the catalytic properties. The ion exchange of H⁺ or Na⁺ by transition metal cations can be carried out both in liquid and in solid form wherein different transition metal cations can also be introduced simultaneously or in succession in several exchange steps. In addition, gas phase exchange processes are known, which are however too expensive for industrial processes. A disadvantage with the present state of the art is that in the case of solid ion exchange, although a defined quantity of metal ions can be introduced into the titano-(silico)-alumino-phosphate framework, there is no homogeneous distribution of the metal ions. By contrast, in the case of liquid ion exchange a homogeneous metal ion distribution in the titano-(silico)-alumino-phosphate can be achieved. However, in the case of liquid aqueous ion exchange a disadvantage with small-pored molecular sieves is that the hydration sheath of the metal ions is too big for the metal ions to be able to penetrate the small pore openings and the exchange rate is thus only very low. In addition to the named methods, doping or modifying can be carried out with one or more metal cations by aqueous impregnation or the incipient wetness method. These doping or modifying methods are known in the state of the art. It is particularly preferred that the doping or modifying is carried out by means of one or more metal compounds by aqueous ion exchange, wherein both metal salts and metal complexes are used to supply ions.

The molecular sieve modified with the transition metal cation preferably has the following formula:

[(TiₓAl_{y}Si_{z}P_{q})O₂]^{-a}[M^{b+}]_{a/b},

wherein the symbols and indices used have the following meanings: x+y+z+q=1; 0.010≦x≦0.110; 0.400≦y≦0.550; 0≦z≦0.090; 0.350≦q≦0.450; a=y−q (with the proviso that y is preferably greater than q); M^{b+} represents the transition metal cation with the charge b+, wherein b is an integer greater than or equal to 1, preferably 1, 2, 3 or 4, even more preferably 1, 2 or 3 and most preferably 1 or 2.

The number of negative charges a of the molecular sieve is obtained from the number of aluminium atoms in excess of the number of phosphorus atoms. If it is assumed that there are two oxygen atoms to each Ti, Al, Si and P atom, these units would then have the following charges: The unit TiO₂ and the unit SiO₂ are neutral in charge, the unit AlO₂ has a negative charge due to the trivalency of aluminium and the unit PO₂ has a positive charge due to the pentavalency of phosphorus. It is particularly preferable according to the invention that the number of aluminium atoms is greater than the number of phosphorus atoms, with the result that the molecular sieve is negatively charged overall. In the above-named formula this is expressed by the index a, which represents the difference of the aluminium atoms present minus the phosphorus atoms. This is therefore in particular the case, as neutrally charged TiO₂ or SiO₂ units are substituted for positively charged PO₂⁺ units.

In addition to the named SiO₂, TiO₂, AlO₂⁻ and PO₂⁺ units which form the framework of the molecular sieve and the ratio of which determines the valency of the molecular sieve, the molecular sieve can also contain Al and P units which, as such, are formally to be regarded as neutral in charge, for example, because it is not O₂⁻ units that occupy the coordination sites, but because other units, such as for example OH⁻ or H₂O, are situated at this site, preferably if they are present at the terminal or edge position in the structure. This portion of these units is then referred to as the so-called “extra framework” of the molecular sieve.

The molecular sieve used in the method according to the invention preferably has a (Ti)/(Al+P) molar ratio or (Si+Ti)/(Al+P) molar ratio of 0.01-0.5 to 1, more preferably 0.02-0.4 to 1, even more preferably 0.05-0.3 to 1 and most preferably 0.07-0.2 to 1.

It is also particularly preferable that the molecular sieve used in the method according to the invention contains Si as an essential element—in addition to Ti. In particular the silicon-containing titano-alumino-phosphate is characterized by its high hydrothermal stability.

The Si/Ti ratio preferably lies within the range of from 0 to 20, more preferably within the range of from 0.5 to 10, even more preferably within the range of from 1 to 8. The Al/P ratio with respect to all the units of the molecular sieve, i.e. those of the framework and of the extra framework of the titano-(silico)-alumino-phosphate, preferably lies within the range of from 0.5 to 1.5, more preferably within the range of from 0.70 to 1.25. The Al/P ratio only with respect to the framework of the titano-(silico)-alumino-phosphate preferably lies within the range of from greater than 1 to 1.5, more preferably within the range of from 1.05 to 1.25.

The transition metal cation present in the transition metal cation-modified molecular sieve preferably lies within the range of from 0.01 wt. % to 20 wt. %, preferably within the range of from 0.1 to 10 wt. %, more preferably within the range of from 0.2 to 8 wt. % and most preferably 0.5 to 7 wt. % relative to the total weight of the molecular sieve.

The transition metal cation can be any cation of a transition metal that can be used as catalytically active element in SCR and SCO applications within the meaning of this invention. Iron, copper, chromium, manganese, cobalt, platinum, palladium, rhodium, silver, gold, in particular copper are particularly preferred as metal of the transition metal cation.

After the production of the transition metal-modified molecular sieve, this is usually present in the form of a powder. These molecular sieves which are then present as powder are then either shaped into extrudates, shaped into full extrudates/honeycomb catalysts with the aid of oxidic and/or organic binders, or applied to ceramic or metallic support bodies, in particular honeycomb-shaped support bodies via the intermediate stage of a washcoat. The molecular sieve used in the method according to the invention is preferably present as full extrudate or on a support body in the form of a coating.

In particular the full extrudates are produced in the form of honeycombs or the support bodies coated with the full extrudate are preferably honeycomb-shaped support bodies.

If the molecular sieve used in the method according to the invention is present in the form of a full extrudate, the full extrudate preferably comprises the titano-(silico)-alumino-phosphate and at least one oxidic and/or organic binder.

The full extrudate is preferably produced by extrusion of a catalytically active composition comprising the transition metal-modified molecular sieve and at least one oxidic and/or organic binder. The full extrudate is preferably an extrudate in honeycomb form. The named composition can also contain further metal oxides, promoters, stabilizers and/or fillers in addition to the binders. In this composition the transition metal cation-modified titano-(silico)-alumino-phosphate present preferably lies within the range of from 5 to 95 wt. %, more preferably 50 to 90 wt. % relative to the total composition.

If the molecular sieve is present on a support body in the form of a coating, in order to produce the coated support body the named composition is preferably processed into a washcoat which is suitable for coating support bodies. Such a washcoat preferably comprises 5 to 90 wt. %, more preferably 10 to 80 wt. %, particularly preferably 10 to 70 wt. % titano-(silico)-alumino-phosphate used in the method according to the invention relative to the total mass of the washcoat. The washcoat according to the invention contains water or a solvent as well as binder in addition to the above-named components. The binder of the composition, when applied to a support body, serves to bind the molecular sieve. The solvent serves to allow both the molecular sieve and the binder to be applied to the catalyst support in the form of a coating.

The present invention also relates to the use of a titano-(silico)-alumino-phosphate for producing exhaust gas purification catalyst components. Here too the preferred variants of the titano-(silico)-alumino-phosphate used in the method according to the invention are preferred. By exhaust gas purification catalyst components are meant units in exhaust gas streams, in which the above-defined catalysts are present, and in which in the case of SCR applications the nitrogen oxides are reduced or in the case of SCO applications the nitrogen-hydrogen compounds such as ammonia and the nitrogen-containing organic compounds are oxidized.

Accordingly the present invention also relates to exhaust gas purification catalyst components comprising a titano-(silico)-alumino-phosphate. Here too the preferred variants of the titano-(silico)-alumino-phosphate used in the method according to the invention are preferred.

### FIGURES

FIGS. 1 to 7 are intended to further illustrate the present invention:

FIG. 1: shows the conversion of NOₓ in the SCR reaction for embodiment example 1 (fresh—Test 1 and aged—Test 2) and for comparison example 1 depending on the temperature.

FIG. 2: shows the conversion of NH₃ in the SCR reaction for embodiment example 1 (fresh—Test 1 and aged—Test 2) and for comparison example 1 depending on the temperature.

FIG. 3: shows the conversion of NOₓ in the SCR reaction for embodiment example 2, for comparison example 2 and for comparison example 3 depending on the temperature (Test 3).

FIG. 4: shows the conversion of NH₃ in the SCR reaction for embodiment example 2, for comparison example 2 and for comparison example 3 depending on the temperature (Test 3).

FIG. 5: shows the formation of N₂O (yield relative to NH₃) in the SCR reaction for embodiment example 2, for comparison example 2 and comparison example 3 depending on the temperature (Test 3).

FIG. 6: shows the conversion of NH₃ in the SCO reaction for embodiment example 2 and for comparison example 2 depending on the temperature (Test 4).

FIG. 7: shows the formation of N₂O (yield relative to NH₃) in the SCO reaction for embodiment example 2 and for comparison example 2 depending on the temperature (Test 4).

The present invention is now illustrated in non-limiting manner with the help of the following examples:

### EXAMPLES

### Embodiment Example 1

500 g of CuTAPSO-34 (5.3 wt. % Cu, producer Sud-Chemie AG) was shaped with 100 g of Pural SB (Sasol Germany GmbH), 133.3 g of H₂O, 16.7 g of HNO₃ conc., 10.7 g of glycerol (65% p.a., Merck) and 270.3 g of Tylose solution (70 g of Tylose MH50 G4 DEAC 098000 (ShinEtsu) in 1000 g of demin. H₂O) to form strand-shaped extrudates with a diameter of approximately 1.6 mm and a length of 0.5 to 5 mm. The extrudates were then dried for 16 h at 120° C. and calcined at 500° C. (heating rate 1° C./min.) for 5 h in air.

### Embodiment Example 1

### Aged

The extrudates of embodiment example 1 were heated up to 700° C. and aged at this temperature for 24 h in a water vapour atmosphere (10% volume percent H₂O).

### Comparison Example 1

CuZSM-5 (4% wt. % Cu, producer Mizusawa) was shaped with 100 g of Pural SB (Sasol Germany GmbH), 133.3 g of H₂O, 16.7 g of HNO₃ conc., 10.7 g of glycerol (65% p.a., Merck) and 242 g of Tylose solution (140 g of Tylose MH50 G4 DEAC 098000 (ShinEtsu) in 2000 g of demin. H₂O) to form strand-shaped extrudates with a diameter of approximately 1.6 mm and a length of 0.5 to 5 mm. The extrudates were then dried for 16 h at 120° C. and calcined at 500° C. (heating rate 1° C./min.) for 5 h in air.

Both the catalyst according to the invention and the comparison example were tested in the selective catalytic reduction of NOₓ with NH₃ in the presence of oxygen and water vapour in a fixed-bed reactor lined with quartz tubing to suppress blind reactions. The test conditions are shown in Table 1 below.

TABLE 1

| | | Test gas composition (remainder N₂) | | | | |
|---|---|---|---|---|---|---|
| | GHSV | NH₃ | | NO₂ | H₂O | |
| Test | [h⁻¹] | [ppmv] | NO [ppmv] | [ppmv] | [vol.-%] | O₂ [vol.-%] |
| 1 | 30000 | 250 | 225 | 30 | 2.6 | 2.9 |
| 2 | 30000 | 450 | 360 | 40 | 2.6 | 2.9 |

For the test gas composition, NH₃/NOₓ=0.91 applies for the fresh catalyst samples (Test 1), with the result that the maximum NOₓ conversion cannot exceed 91%. In the case of the aged sample (Test 2) the NH₃/NOₓ ratio was =1.15, with the result that a maximum of 87% of the ammonia can be converted by nitrogen oxides. The excess ammonia is here converted by oxygen according to the SCO reaction.

### Embodiment Example 2

A washcoat was produced from 100 g of deionized water, 100 g of copper-containing TAPSO-34 (copper: 5.3 wt. %, Sud-Chemie AG), 22.6 g of Bindzil 2034DI (EKA Chemicals) and 4.4 g of 65% nitric acid (Merck). A ceramic substrate (75 mm*100 mm, 200 cpsi from Rauschert) was dipped in the washcoat. After drying, the honeycomb was heated from 40° C. to 550° C. within 4 h in air and kept at this temperature for 3 h.

### Comparison Example 2

A washcoat was produced from 800 g of deionized water, 666.5 g of copper-containing zeolite Beta (copper: 3.8 wt. %, Sud-Chemie AG), 160 g of Bindzil 2034DI (EKA Chemicals) and 26.5 g of 65% nitric acid (Merck). A cordierite honeycomb (ø 20 mm, 75 mm, 200 cpsi from Rauschert) was dipped in the washcoat. After drying, the honeycomb was heated from 40° C. to 550° C. within 4 h in air and kept at this temperature for 3 h.

### Comparison Example 3

A washcoat was produced from 100 g of deionized water, 111.1 g of copper-containing SAPO-34 (copper: 5.6 wt. %, Sud-Chemie AG) and 22.65 g of Bindzil 2034DI (EKA Chemicals). A ceramic substrate (75 mm*100 mm, 200 cpsi from Rauschert) was dipped in the washcoat. After drying, the honeycomb was heated from 40° C. to 550° C. within 4 h in air and kept at this temperature for 3 h.

Both the catalyst according to the invention and the catalysts of comparison examples 2 and 3 were tested in the selective catalytic reduction of NOₓ with NH₃ in the presence of oxygen and water vapour in a fixed-bed reactor lined with quartz tubing to suppress blind reactions. The test conditions are shown in Table 2 below.

TABLE 2

| | | Test gas composition (remainder N₂) | | | | |
|---|---|---|---|---|---|---|
| | GHSV | NH₃ | | NO₂ | H₂O | |
| Test | [h⁻¹] | [ppmv] | NO [ppmv] | [ppmv] | [vol.-%] | O₂ [vol.-%] |
| 3 | 30000 | 450 | 360 | 40 | 2.6 | 2.9 |
| 4 | 20000 | 1000 | — | — | 0.2 | 20.5 |

The NH₃/NOₓ ratio=1.15 applies for the gas composition in Test 3, with the result that a maximum of 87% of the ammonia can be converted by nitrogen oxides. The excess ammonia is here converted by oxygen according to the SCO reaction. Test 4 corresponds to the selective catalytic oxidation (SCO) of ammonia with air.

### Results:

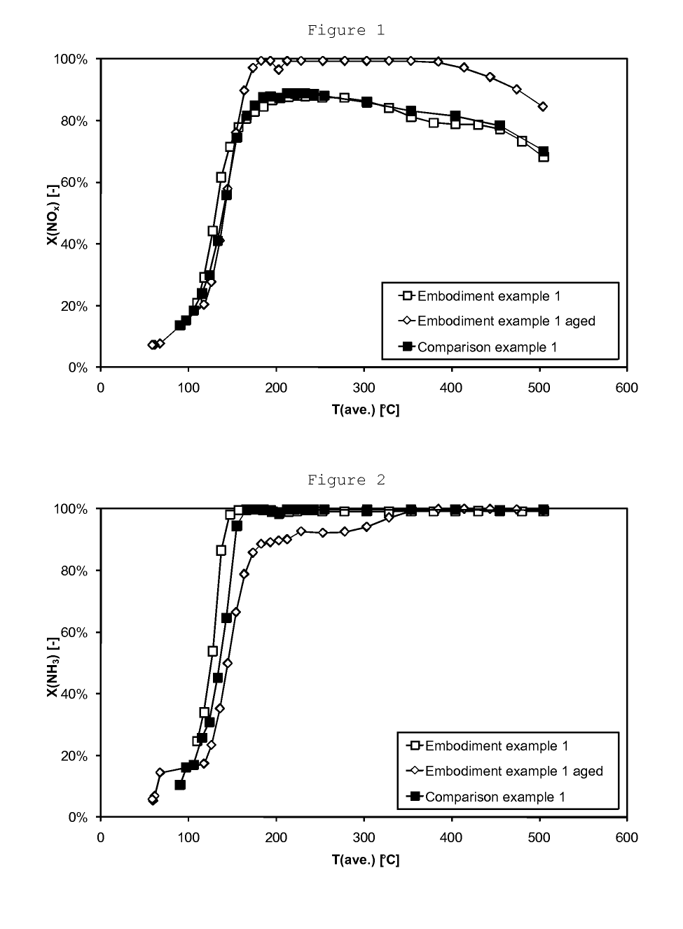

FIGS. 1 and 2 and Table 3 show the conversions measured for NOₓ and NH₃ of the catalyst samples produced in embodiment example 1 and comparison example 1 in the SCR reaction. Both with respect to NOₓ and with respect to NH₃ the conversions measured for embodiment example 1 are higher than in the case of comparison example 1. Both samples show no measurable formation of laughing gas.

TABLE 3

| | | | Embodiment | | | Embodiment | | |
|---|---|---|---|---|---|---|---|---|
| Comparison example 1 | | | example 1 fresh | | | example 1 aged | | |
| (Test 1) | | | (Test 1) | | | (Test 2) | | |
| T | | | T | | | T | | |
| (ave.) | NOₓ [%] | NH₃ [%] | (ave.) | NOₓ [%] | NH₃ [%] | (ave.) | NOₓ [%] | NH₃ [%] |
| [° C.] | conversion | conversion | [° C.] | conversion | conversion | [° C.] | conversion | conversion |
| 504.4 | 70.12 | 99.73 | 504.7 | 68.19 | 99.23 | 504.1 | 84.42 | 99.24 |
| 454.5 | 78.45 | 99.48 | 480.1 | 73.32 | 99.23 | 474.2 | 90.03 | 99.66 |
| 403.8 | 81.50 | 99.74 | 454.9 | 77.28 | 99.28 | 443.9 | 94.10 | 99.84 |
| 353.2 | 83.14 | 99.76 | 429.7 | 78.69 | 99.24 | 414.2 | 97.06 | 99.87 |
| 303.4 | 85.91 | 99.71 | 404.4 | 78.82 | 99.24 | 384.8 | 98.93 | 99.82 |
| 254.9 | 88.01 | 99.73 | 378.9 | 79.33 | 99.19 | 353.7 | 99.27 | 99.33 |
| 242.9 | 88.68 | 99.76 | 353.6 | 81.25 | 99.17 | 328.6 | 99.29 | 96.99 |
| 232.6 | 88.92 | 99.77 | 328.4 | 84.15 | 99.15 | 303.2 | 99.29 | 94.03 |
| 221.7 | 88.84 | 99.74 | 302.9 | 86.21 | 99.13 | 278.2 | 99.29 | 92.44 |
| 212.3 | 88.87 | 99.76 | 277.3 | 87.41 | 99.15 | 253.3 | 99.29 | 92.09 |
| 203.4 | 87.38 | 98.41 | 252.5 | 87.46 | 99.12 | 228.6 | 99.29 | 92.59 |
| 193.3 | 87.89 | 99.61 | 242.9 | 88.09 | 99.65 | 212.7 | 99.28 | 89.93 |
| 185.2 | 87.63 | 99.65 | 233.3 | 87.88 | 99.72 | 203.2 | 96.42 | 89.56 |
| 175.4 | 84.97 | 99.76 | 223.6 | 88.14 | 99.16 | 193.5 | 99.29 | 89.02 |
| 166.2 | 81.53 | 99.55 | 214.2 | 87.78 | 98.99 | 182.9 | 99.29 | 88.45 |
| 154.9 | 74.50 | 94.44 | 204.5 | 87.18 | 98.99 | 173.7 | 97.03 | 85.67 |
| 143.3 | 55.93 | 64.67 | 195.4 | 86.73 | 99.06 | 163.7 | 89.60 | 78.64 |
| 133.0 | 41.05 | 45.22 | 185.3 | 84.46 | 99.81 | 154.4 | 76.04 | 66.36 |
| 123.7 | 29.93 | 30.69 | 175.3 | 82.82 | 99.85 | 145.0 | 57.83 | 49.82 |
| 115.3 | 23.94 | 25.80 | 165.6 | 80.48 | 99.86 | 136.2 | 41.03 | 35.17 |
| 106.0 | 18.41 | 16.97 | 156.9 | 77.84 | 99.65 | 126.2 | 27.53 | 23.36 |
| 97.4 | 15.27 | 16.09 | 147.0 | 71.61 | 98.16 | 117.9 | 20.24 | 17.32 |
| 90.2 | 13.55 | 10.40 | 137.2 | 61.64 | 86.49 | 67.9 | 7.60 | 14.42 |
| | | | 127.4 | 44.25 | 53.85 | 61.8 | 7.13 | 6.85 |
| | | | 117.7 | 29.16 | 33.96 | 59.8 | 7.11 | 5.29 |
| | | | 109.9 | 20.97 | 24.69 | 59.2 | 7.13 | 5.79 |

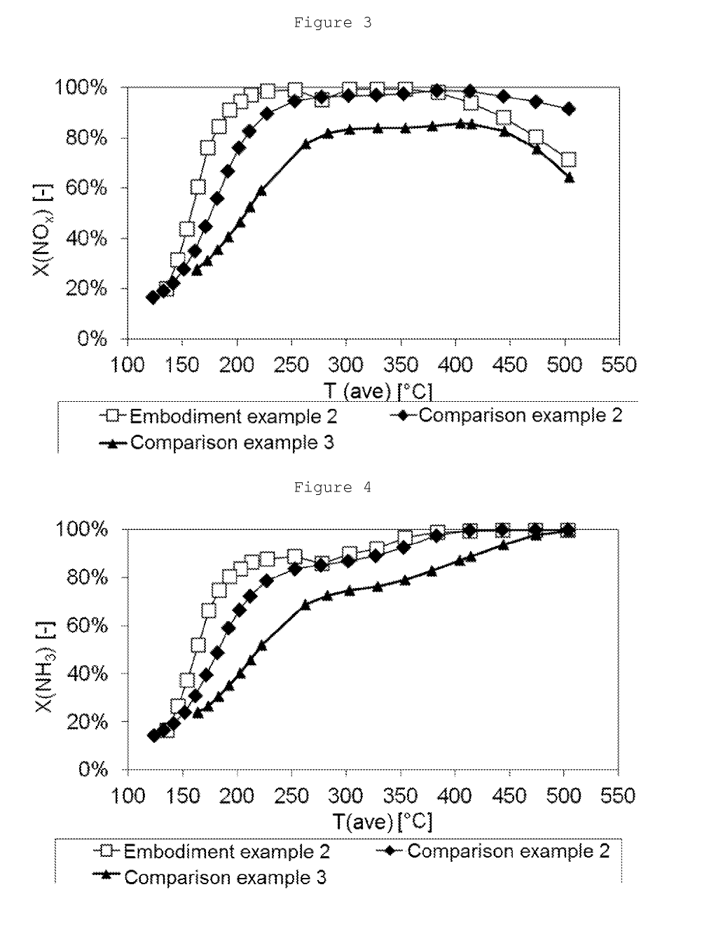

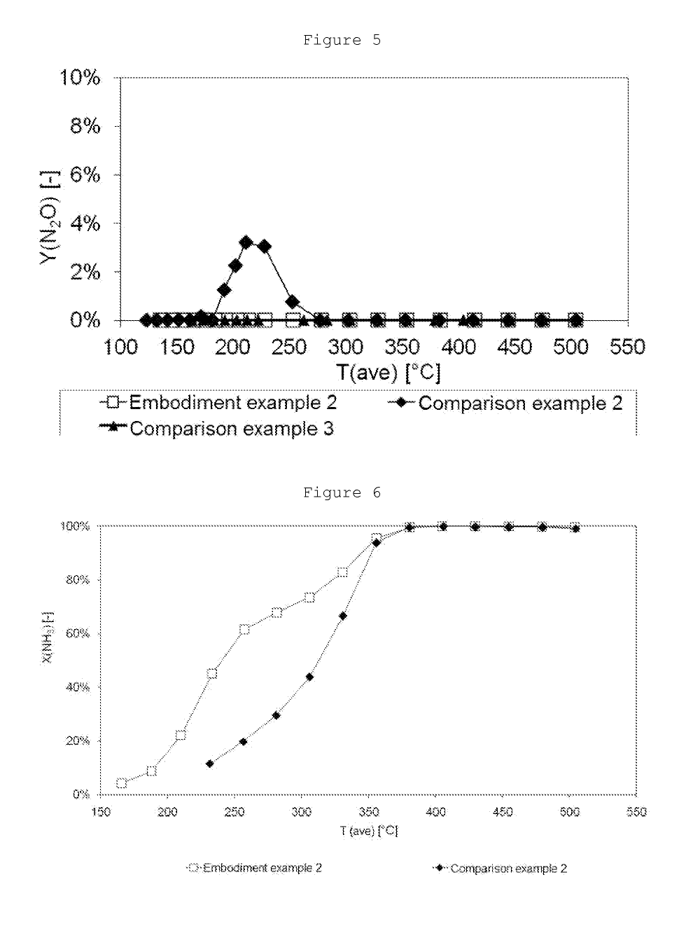

FIGS. 3, 4 and 5 and Tables 4 and 5 show the conversions measured with respect to ammonia and nitrogen oxides (test gas composition according to Test 3) as well as the yield of laughing gas of the catalyst samples produced in embodiment example 2 and comparison examples 2 and 3 in the SCR reaction. Both with respect to NOₓ and with respect to NH₃ the conversions measured for embodiment example 2 are higher than in the case of comparison examples 2 and 3. The sample in comparison example 2 also shows a small, but undesired formation of laughing gas, which is not to be observed in the case of embodiment example 2.

TABLE 4

| Comparison example 2 (Test 3) | | | | Embodiment example 2 (Test 3) | | | |
|---|---|---|---|---|---|---|---|
| T | | | | T | | | |
| (ave.) | NOₓ [%] | NH₃ [%] | N₂O [ppmv] | (ave.) | NOₓ [%] | NH₃ [%] | N₂O [ppmv] |
| [° C.] | conversion | conversion | formation | [° C.] | conversion | conversion | formation |
| 503.5 | 91.54 | 99.78 | 0 | 503.5 | 71.32 | 99.56 | 0 |
| 473.5 | 94.28 | 99.85 | 0 | 473.7 | 80.25 | 99.67 | 0 |
| 443.4 | 96.56 | 99.85 | 0 | 443.8 | 87.98 | 99.68 | 0 |
| 413.1 | 98.47 | 99.66 | 0 | 413.9 | 93.96 | 99.39 | 0 |
| 382.8 | 98.74 | 97.54 | 0 | 383.8 | 98.06 | 98.82 | 0 |
| 352.6 | 97.39 | 92.57 | 0 | 353.8 | 99.23 | 96.49 | 0 |
| 327.1 | 96.94 | 88.90 | 0 | 328.6 | 99.23 | 91.97 | 0 |
| 301.9 | 96.75 | 86.74 | 0 | 303.3 | 99.27 | 89.89 | 0 |
| 277.1 | 96.21 | 85.28 | 0 | 278.0 | 95.12 | 85.64 | 0 |
| 252.7 | 94.63 | 83.48 | 1.80 | 252.9 | 99.15 | 88.77 | 0 |
| 227.4 | 89.69 | 78.84 | 6.99 | 227.9 | 98.59 | 87.53 | 0 |
| 211.4 | 82.57 | 72.35 | 7.38 | 213.4 | 97.12 | 86.35 | 0 |
| 201.9 | 75.98 | 66.44 | 5.18 | 203.4 | 94.33 | 83.59 | 0 |
| 191.7 | 66.63 | 58.82 | 2.92 | 193.0 | 90.89 | 80.27 | 0 |
| 181.7 | 55.89 | 48.57 | 0 | 183.7 | 84.51 | 74.71 | 0 |
| 171.3 | 44.81 | 39.31 | 0.38 | 173.7 | 76.10 | 66.36 | 0 |
| 161.4 | 35.12 | 30.64 | 0 | 164.3 | 60.43 | 51.84 | 0 |
| 151.5 | 27.71 | 24.03 | 0.07 | 154.3 | 43.72 | 37.31 | 0 |
| 141.6 | 22.24 | 19.38 | 0 | 145.7 | 31.39 | 26.44 | 0 |
| 132.4 | 19.09 | 16.59 | 0 | 135.6 | 19.81 | 16.29 | 0 |
| 123.4 | 16.45 | 14.29 | 0 | | | | |

TABLE 5
Comparison example 3 (Test 3)

| T (ave.) | NOₓ [%] | NH₃ [%] | N₂O [ppmv] |
|---|---|---|---|
| [° C.] | conversion | conversion | formation |
| 504.2 | 64.25 | 99.41 | 0 |
| 474.6 | 75.65 | 97.58 | 0 |
| 444.6 | 82.71 | 93.60 | 0 |
| 414.5 | 85.42 | 88.78 | 0 |
| 404.3 | 85.67 | 87.22 | 0 |
| 378.9 | 84.82 | 82.84 | 0 |
| 353.8 | 83.84 | 78.93 | 0 |
| 328.7 | 83.90 | 76.42 | 0 |
| 303.3 | 83.39 | 74.58 | 0 |
| 283.1 | 81.80 | 72.53 | 0 |
| 262.6 | 77.73 | 68.72 | 0 |
| 222.3 | 58.97 | 51.95 | 0 |
| 212.1 | 52.47 | 45.77 | 0 |
| 202.7 | 46.46 | 40.28 | 0 |
| 192.4 | 40.54 | 35.02 | 0 |
| 182.7 | 35.51 | 30.58 | 0 |
| 173.1 | 31.05 | 26.31 | 0 |
| 163.6 | 27.78 | 23.95 | 0 |
| 163.5 | 27.17 | 23.73 | 0 |

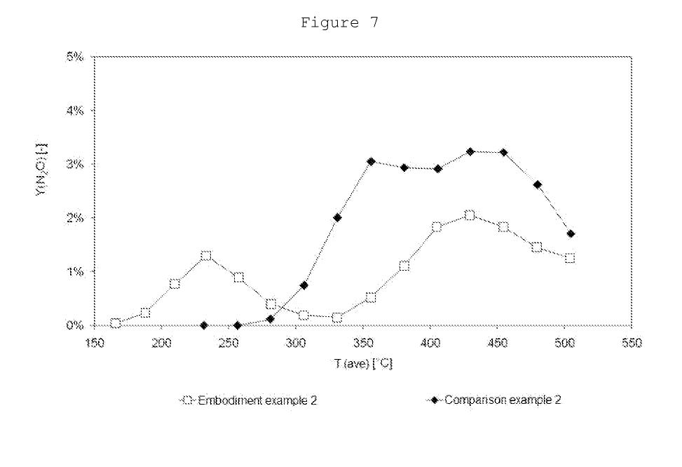

FIGS. 6 and 7 and Table 6 show the conversions measured in the NH₃ oxidation as well as the yields of ammonia of the catalyst samples produced in embodiment example 2 and comparison example 2 in the SCO reaction. The conversions measured for embodiment example 2 are higher than in the case of comparison example 2. In addition, with high ammonia conversions the undesired formation of laughing gas in the case of embodiment example 2 is however lower than in the case of comparison example 2. Furthermore, in the case of both samples a small formation of nitrogen oxides was observed above 450° C., but the yields relative to ammonia were below 3% even at 500° C.

TABLE 6

| Comparison example 2 | | | | | |
|---|---|---|---|---|---|
| (Test 4) | | | | | |
| | NH₃ | | Embodiment example 2 (Test 4) | | |
| T (ave.) | [%] | N₂O [%] | T (ave.) | NH₃ | H₂O [%] |
| [° C.] | conversion | selectivity | [° C.] | [%] conversion | selectivity |
| 504.7 | 99.13 | 1.72 | 504.1 | 99.61 | 1.26 |
| 479.9 | 99.63 | 2.63 | 479.4 | 99.86 | 1.46 |
| 454.7 | 99.78 | 3.23 | 454.8 | 99.92 | 1.83 |
| 429.8 | 99.86 | 3.24 | 429.6 | 99.95 | 2.05 |
| 405.8 | 99.90 | 2.92 | 404.9 | 99.95 | 1.83 |
| 380.6 | 99.65 | 2.95 | 380.7 | 99.61 | 1.11 |
| 355.9 | 93.88 | 3.25 | 355.9 | 95.49 | 0.54 |
| 330.8 | 66.62 | 3.01 | 330.8 | 82.80 | 0.18 |
| 305.9 | 43.86 | 1.70 | 305.9 | 73.43 | 0.26 |
| 280.8 | 29.48 | 0.40 | 281.5 | 67.83 | 0.59 |
| 256.3 | 19.68 | 0.00 | 257.4 | 61.57 | 1.45 |
| 231.3 | 11.47 | 0.00 | 233.1 | 45.06 | 2.88 |
| | | | 209.9 | 22.12 | 3.49 |
| | | | 187.9 | 8.69 | 2.66 |
| | | | 165.8 | 4.16 | 1.03 |

1. Method for the selective catalytic conversion of nitrogen-containing compounds in exhaust gas streams, wherein a catalyst that comprises titano-alumino-phosphate or titano-silico-alumino-phosphate is used.

2. Method according to claim 1, wherein the conversion of nitrogen-containing compounds is the reduction of nitrogen oxides.

3. Method according to claim 2, wherein NH₃, urea, carbon monoxide or hydrocarbon compounds are used as reducing agent.

4. Method according to claim 1, wherein the conversion of nitrogen-containing compounds is the oxidation of nitrogen-hydrogen compounds and/or nitrogen-containing organic compounds.

5. Method according to claim 4, wherein oxygen-containing gases, air or laughing gas are used as oxidant.

6. Method according to claim 1, wherein the titano-alumino-phosphate or titano-silico-alumino-phosphate has a BET surface area within the range of from 200 to 1200 m²/g.

7. Method according to claim 1, wherein a catalyst that comprises titano-silico-alumino-phosphate is used.

8. Method according to claim 7, wherein the titano-silico-alumino-phosphate is TAPSO-34.

9. Method according to claim 1, wherein the titano-alumino-phosphate or titano-silico-alumino-phosphate is present modified with at least one transition metal cation.

10. Method according to claim 9, wherein the titano-alumino-phosphate or titano-silico-alumino-phosphate modified with the at least one transition metal cation has the following formula:
[(TiₓAl_{y}Si_{z}P_{q})O₂]^{-a}[M^{b+}]_{a/b};
wherein the symbols and indices used have the following meanings: x+y+z+q=1; 0.010≦x≦0.110; 0.400≦y≦0.550; 0≦z≦0.090; 0.350≦q≦0.450; a=y−q; M^{b+} represents at least one transition metal cation with the charge b+, wherein b is an integer greater than or equal to 1.

11. Method according to claim 9, wherein the at least one transition metal cation is a cation of a metal selected from the group consisting of iron, copper, chromium, manganese, cobalt, platinum, palladium, rhodium, silver and gold.

12. Method according to claim 9, wherein the at least one transition metal cation present in the titano-alumino-phosphate or titano-silico-alumino-phosphate lies within the range of from 0.01 wt. % to 20 wt. % relative to the total weight of the titano-alumino-phosphate or titano-silico-alumino-phosphate.

13. Method according to claim 1, wherein the titano-alumino-phosphate or titano-silico-alumino-phosphate has a (Ti)/(Al+P) molar ratio or (Si+Ti)/(Al+P) molar ratio within the range of from 0.01 to 0.5.

14. Method according to claim 1, wherein the titano-silico-alumino-phosphate has an Si/Ti molar ratio within the range of from 0 to 20 and/or the titano-alumino-phosphate or titano-silico-alumino-phosphate has an Al/P ratio within the range of from greater than 1 to 1.5.

15. Method according to claim 1, wherein the titano-alumino-phosphate or titano-silico-alumino-phosphate is present as full extrudate or on a support body in the form of a coating.

16. Method according to claim 1, wherein the conversion takes place at a temperature within the range of from 50° C. to 550° C.

17. Use of a titano-alumino-phosphate or titano-silico-alumino-phosphate for the selective catalytic conversion of nitrogen-containing compounds.

18. Use of a titano-alumino-phosphate or titano-silico-alumino-phosphate for the production of an exhaust gas purification catalyst component.

19. Exhaust gas purification catalyst component comprising a titano-alumino-phosphate or titano-silico-alumino-phosphate.
